(19) United States
(12) Patent Application Publication
(10) Pub. No.: US 2003/0057247 A1
(43) Pub. Date: Mar. 27, 2003

(54) Window glass remover

(76) Inventors: Bruce Farr, Spring Lake, MI (US); Jayson I. Skogler, Spring Lake, MI (US)

Correspondence Address: Waters & Morse, P.C., 400 Ledyard Building, 125 Ottawa, Avenue, NW, Grand Rapids, MI, 49503, US

(21) Appl. No.: 10/223,582

(22) Filed: Aug. 19, 2002

Related U.S. Application Data
(60) Provisional application No. 60/313,399, filed on Aug. 17, 2001.

(51) Int. Cl. B26F 3/00

(52) U.S. Cl. 225/93

(57) ABSTRACT

A window glass remover for removing broken window glass from a frame comprises a mat formed of a sheet of flexible backing material shaped to substantially cover the window, a layer of adhesive on one side of the backing material, and a manually graspable handle on an opposite side of the backing material. The adhesive layer adheres to the glass so that when the window is broken, the resulting glass fragments are retained on the sheet by the adhesive. The sheet can include a marked hole or an incorporated bead for facilitating glass breakage. The handle can be formed of a foldable flexible sheet material so the mat and handle can be rolled up and stored in a tube for compact storage. Strips of mat material without a handle can be applied to a window frame after glass removal to protect against glass fragments retained in the frame.

### CROSS-REFERENCES TO RELATED APPLICATIONS

This application is based on and claims the benefit of the filing date of applicants' copending provisional patent application No. 60/313,399, the disclosure of which is incorporated herein by reference.

### STATEMENT REGARDING FEDERALLY SPONSORED RESEARCH OR DEVELOPMENT

Not Applicable.

### BACKGROUND OF THE INVENTION

The present invention relates to a safety device for removing glass from windows, such as in a vehicle, by breaking the glass, wherein the safety device adheres to the glass and permits removal of the glass without spraying glass fragments into the vehicle.

A common problem in rescue operations is the removal of people trapped inside a vehicle after an accident. The easiest way to provide access to a vehicle is by breaking the glass, and there are a number of portable glass breaking tools that are useful for this purpose. However, breaking a glass window in a vehicle with a passenger immediately on the other side of the glass causes glass fragments to be sprayed inside the vehicle. This can cause serious injury to the trapped passenger.

An object of the present invention is to provide a means for removing a glass window from a vehicle or the like by breaking the glass without spraying glass fragments into the vehicle.

### SUMMARY OF THE INVENTION

In accordance with the present invention, a window glass remover for removing broken window glass from a frame comprises a mat formed of a sheet of flexible backing material shaped to substantially cover the window, a layer of adhesive on one side of the backing material, and a manually graspable handle on an opposite side of the backing material. The materials are constructed and formed such that the side of the sheet having an adhesive layer adheres to the glass when applied to the side of the window. The window can thereafter be broken, and the resulting glass fragments will be retained on this sheet by the adhesive. The sheet and fragments can be removed with the handle.

In one aspect of the present invention, the flexible backing material is sufficiently flexible to conform with the contour of a curved window while at the same time being sufficiently tough and tear resistant that the backing material can support the weight of a broken window. The adhesive desirably is a double-sided adhesive sheet material similar to double sided adhesive tape. The handle can be formed of an adhesive sheet material like the material used for the mat, or it can be a molded handle applied to the side of the sheet material. The handle can be foldable so as to permit the sheet material to be folded or rolled up for packaging.

These and other advantages and features of the present invention will hereinafter appear in conjunction with a detailed description of a preferred embodiment of the invention set forth below and shown in the appended drawings.

### BRIEF DESCRIPTION OF THE DRAWINGS

FIG. 1 is a perspective view showing the application of the window glass remover of the present invention to a vehicle door window.

FIG. 2 is a perspective view similar to FIG. 1 showing the removal of broken glass with the window glass remover.

FIG. 3 is a cross-sectional view taken along line 3-3 of FIG. 1.

FIG. 4 is a cross-sectional view taken along line 4-4 of FIG. 1.

FIG. 5 is an alternative embodiment of the invention wherein a metal bead is laminated between the flexible material and the adhesive in order to facilitate breaking of the glass.

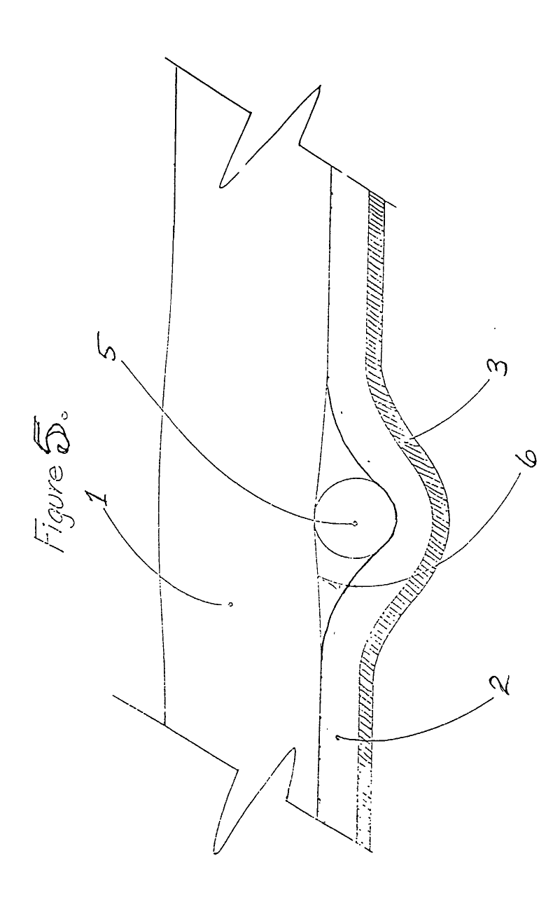

FIG. 6 is a sectional view of an alternative sheet backing material wherein the sheet material is rolled in a roll without release paper covering the adhesive layer.

FIG. 7 is a plan view of a handle formed out of sheet material.

FIG. 8 is a plan view of a handle reinforcement member incorporated into the handle of FIG. 7.

FIG. 9 is a perspective view showing the assembly of the handle of FIGS. 7 and 8.

FIG. 10 is a sectional view of the handle of FIGS. 7-9, showing the handle affixed to the sheet material.

FIG. 11 is a side elevational view of an alternative molded handle affixed to the sheet material of the present invention.

### DETAILED DESCRIPTION OF THE INVENTION

Referring to the drawings, a window glass remover 30 constructed in accordance with the present invention is shown in the process of being applied to a side window 21 of a door 23 of a vehicle. The present invention is especially useful in an emergency situation, where the door will not open and a passenger is trapped inside the vehicle and it is necessary to break the window in order to remove the passenger from the vehicle. Window remover 30 is a mat comprising a sheet of plastic backing material 1 having a layer of pressure sensitive adhesive 2 on one side (an inner side) thereof and having a handle 14 mounted on an opposite side (the outer side) thereof. Handle 14 desirably is attached to the exterior side of sheet 1 by adhesive 32, which can be the same as adhesive 2 used for the sheet 1. Other means of attachment can be employed.

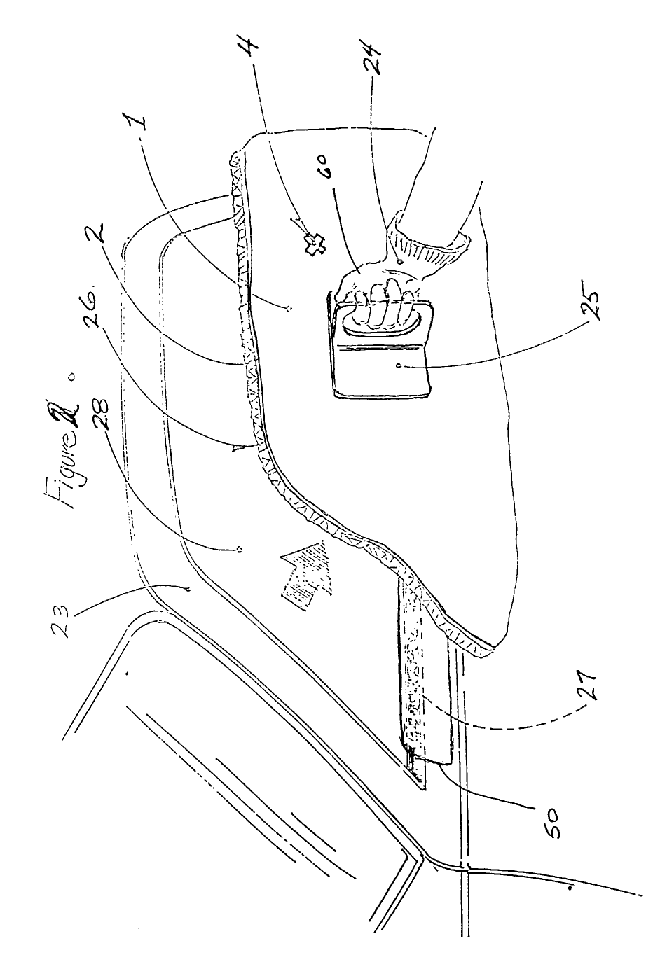

Sheet 1 is formed of a tough plastic sheet material that resists tearing and is sufficiently strong to support the weight of the glass of a broken window. Polyethylene sheeting or a soft vinyl sheeting works, as do other types of sheeting. A thin, fiberglass reinforced sheeting of the type used for wrapping houses (eg., Tyvek brand) is good because it is very tough and tear resistant. While a relatively stiff sheeting will work, it is preferred that the sheeting be thin and flexible enough so it can be rolled up for packaging in a tube. Sheet 1 can be cut in the shape of the window to which it is applied or, preferably, is a larger size that fits all typical windows to which it might be applied. A 23 inch by 44 inch mat is large enough for most applications. The mat is be applied to the window and then is preferably trimmed with a knife. Scrap portions 50 of the mat can be applied over the broken glass 27 or the window sill (on all sides if necessary) to prevent injury while reaching through or removing a passenger through the window (see FIG. 2). A Separate roll of tape formed of the same material as the mat, but about six inches wide, can be used instead of scrap portions of the mat. This material is especially helpful when access is achieved through a window that was previously broken and has sharp fragments around the edge of the window.

The adhesive of the present invention can be any suitable adhesive that is sufficiently able to adhere to a glass surface when the glass is dry, wet, hot, cold, clean or dirty. The adhesive preferably is a double sided adhesive sheet or film, which is commercially available. An aggressive acrylic sheeting is desirable, but a rubber-based adhesive can also be used and may be more aggressive. Other aggressive adhesives can be suitable.

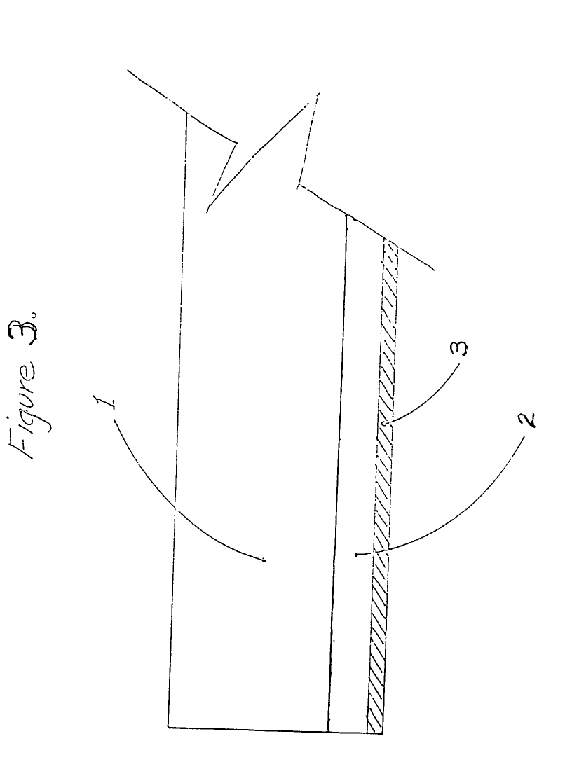

The exterior side of the adhesive sheeting is coated with a release paper 3 (FIG. 3) of conventional characteristics. The release paper is peeled off the adhesive prior to the application of the mat to the glass. Release paper can also be on an interior surface of the adhesive sheeting prior to use. This is removed before applying the adhesive sheeting to the flexible plastic backing material.

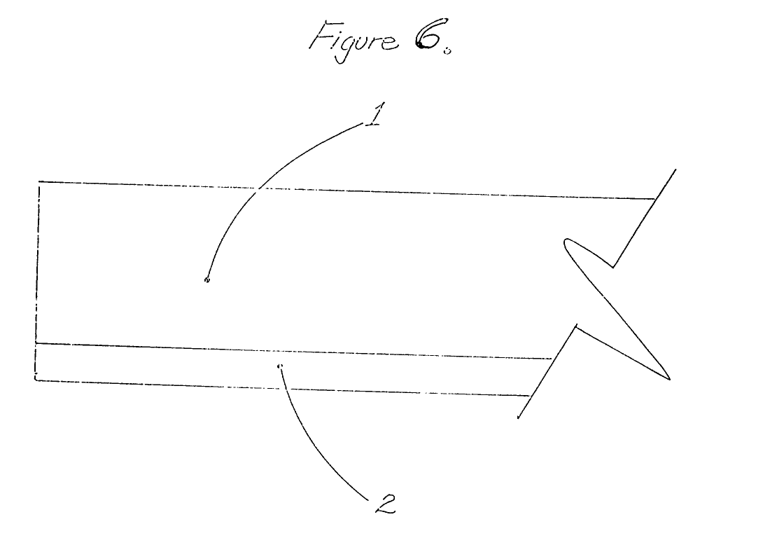

In another aspect of the invention, shown in FIG. 6, the mat is stored in a roll without release paper. In such a case, the adhesive must not be so aggressive that it causes the layers of rolled material to stick so tightly together that the layers cannot be separated easily.

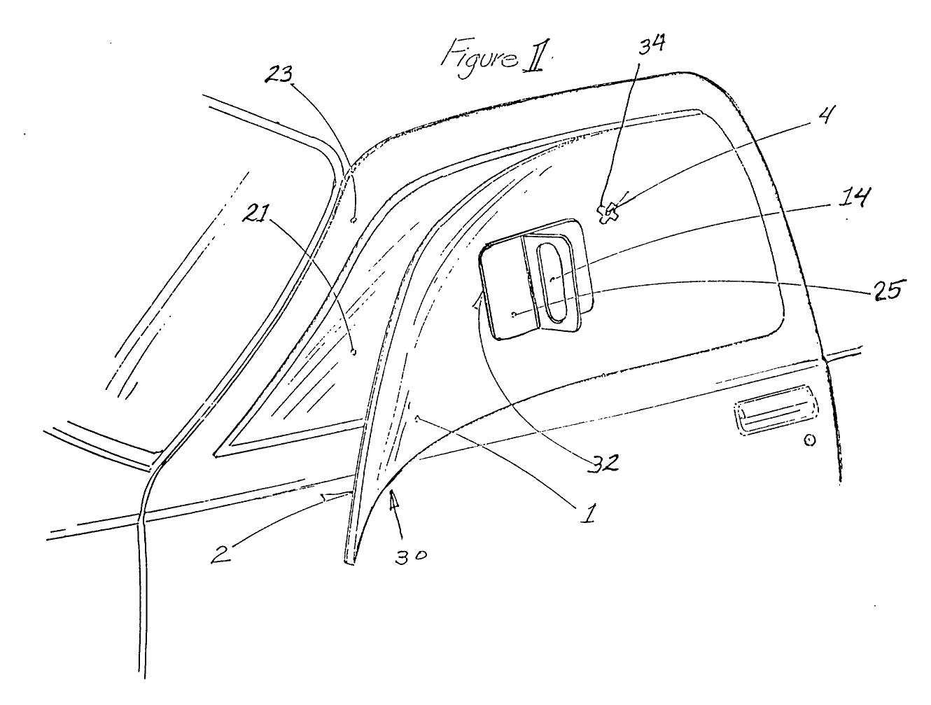

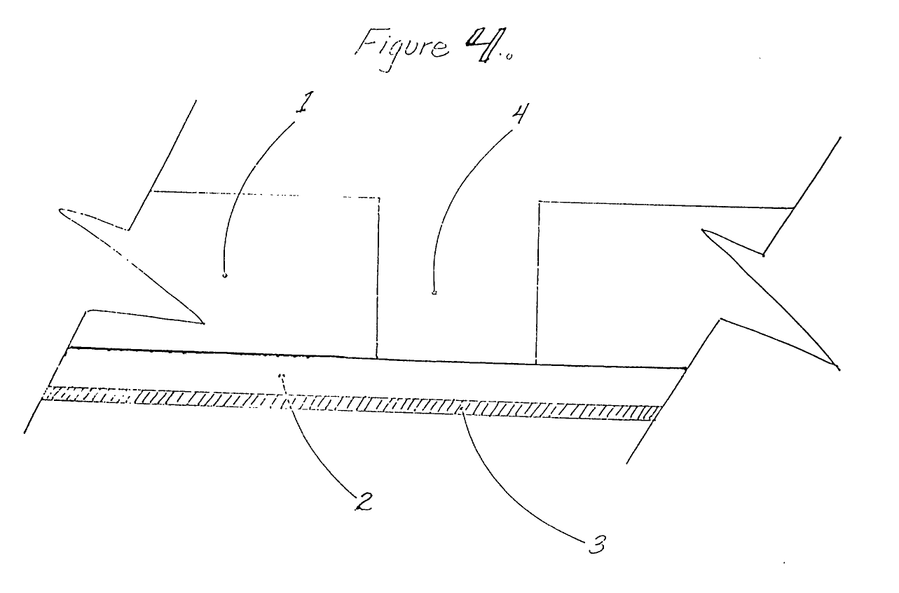

In order to facilitate breaking a window after the mat has been applied to a window, the backing material preferably has a small opening 4 of perhaps 1 mm in diameter extending through the sheet, as shown in FIGS. 1 and 4. An “X” 34 or other visual marker on the exterior of the backing material can be used to identify the location of hole 4. A conventional window breaking device (which is a spring-loaded spike in a handle) can be inserted in hole 4 to break the window. These devices are in common usage for purposes of breaking windows. Alternatively, a spring-loaded center punch, which is readily available at hardware stores, can be used and is quite a bit less expensive than a special glass breaking tool. Also, a hammer and nail or other sharp object can be employed. Hole 4 is not essential. A hammer and nail can be employed anywhere and can pierce the sheet, or a hammer or other rigid object can simply be struck against the window through the sheet at almost any location. With enough force and with a sharp enough object, the glass will break whether or not there is a hole in the sheet material, unless the sheet material is quite rigid.

Instead of employing a hole and using a spring-loaded center punch or the like to break the glass, if desired, a metal bead or BB 5 can be incorporated in the sheet material between the adhesive layer 2 and the sheet material 1. A hammer or other instrument can be struck against the outside of the sheet where the BB 5 is located and the BB will cause a pressure point that will cause the glass to break. In any case, when side or rear glass is broken in a vehicle, the glass, being tempered, shatters into tiny fragments which are, for the most part, retained on the mat by the adhesive layer.

While the bead or BB may be incorporated between the adhesive layer and the sheet material, it would also be possible to insert a BB in a hole in the material and cover the hole with an X-shaped patch. Any other means for achieving a pressure point in proximity to the glass could accomplish the same purpose of facilitating glass breakage.

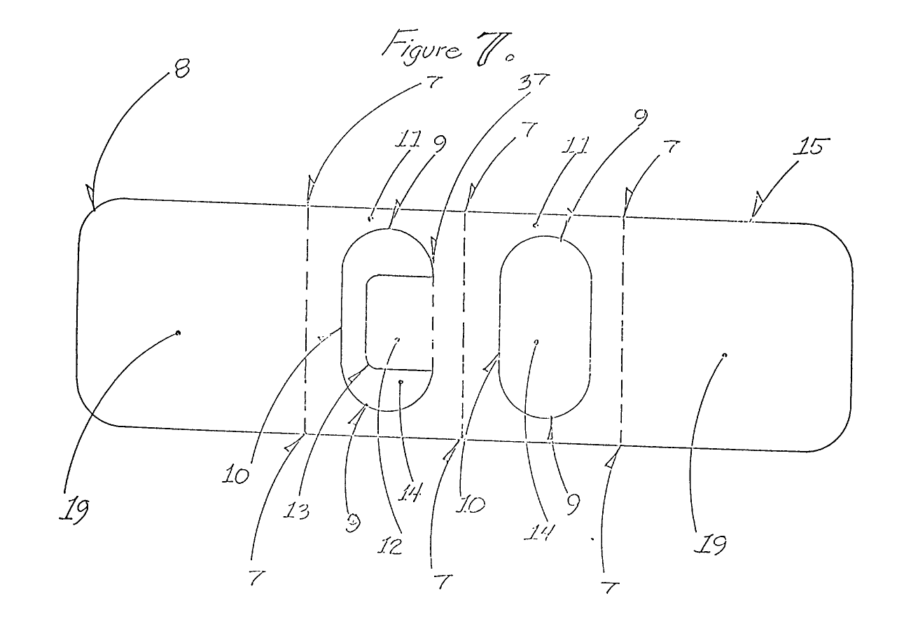

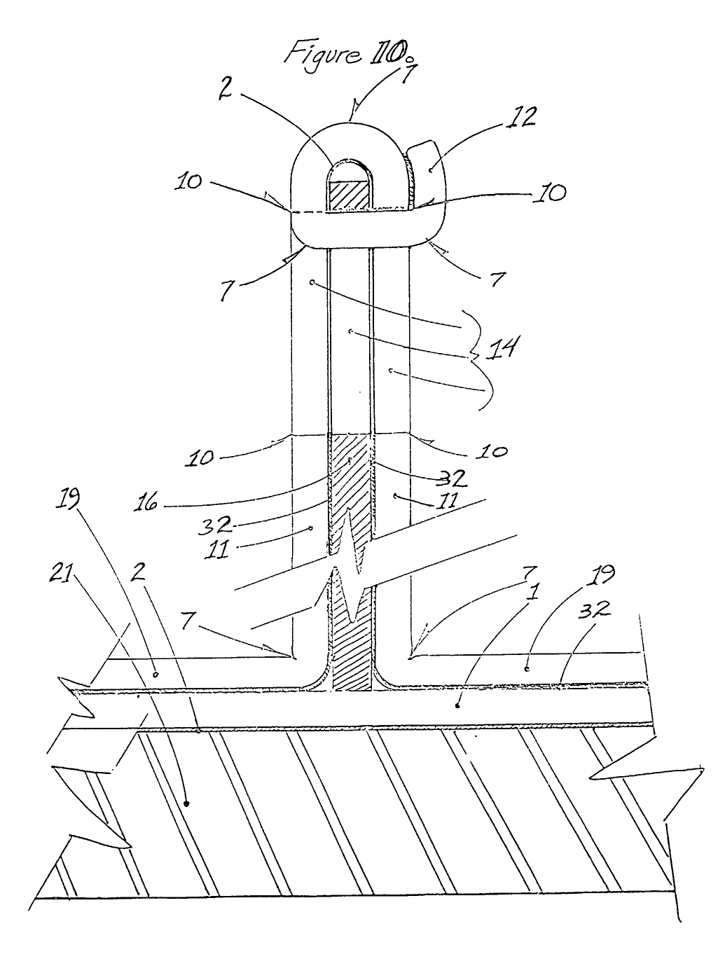

The construction of one embodiment of handle 14 is shown in FIGS. 7-10. As shown in FIG. 7, handle 14 can be formed of the same sheet material as the mat 30 applied to the glass. Sheet material die cut from the same material as the mat is the preferred means for producing the handle of the present invention. Handle 14 is formed in a sheet having an elongated rectangular shape with rounded corners 8. The handle is formed with fold points 7 that are laser cut through the release paper layer. The radii on the four outer perimeter corners 8 is desirably about 1 inch. Fold points 7 are desirably placed in three locations, dividing the elongated panel into outer support flaps 19 on the ends of the panel and hand grip side supports 11 on the interior of the panel. Openings 10 preferably are formed by die cutting in panels 11 for hand gripping. A locking hand grip support flap 12 can be formed adjacent one hand grip opening and is foldable along a fold point 37 adjacent the perimeter of hand opening 10.

As stated above, one entire surface of handle 14 can be coated with the double sided pressure sensitive adhesive sheet 32. At the very least, support flaps 19 must be provided with an adhesive layer so that the support flaps will adhere to the exterior surface of backing material 1.

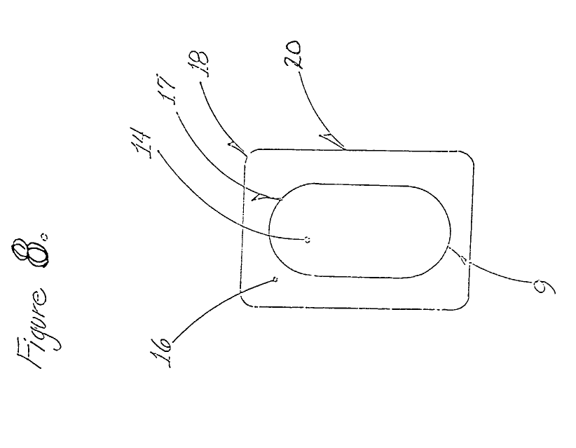

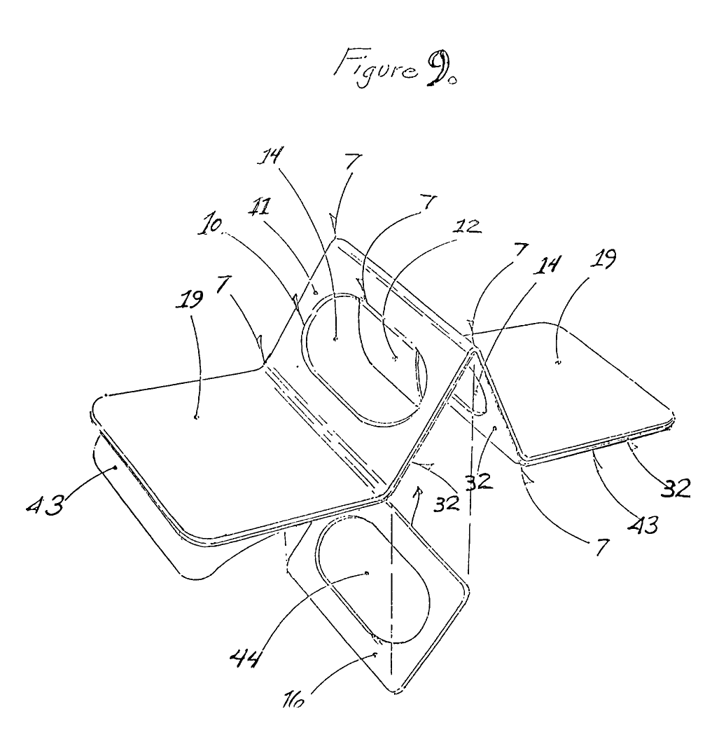

In the preferred practice of the present invention, the handle is reinforced by a die-cut plastic reinforcement member 16 (FIG. 8) shaped in the same general shape as panels 11. Member 16 can be formed of a stiffer material such as PETG (preferred), acrylic, PVC (rigid), ABS, or polycarbonate. Any relatively rigid support panel will suffice. The support is inserted between the hand grip side supports 11 and secured in place by the adhesive backings on the hand grip side supports when the handle is folded together in the manner shown in FIG. 9.

As shown in FIG. 9, the handle is in the process of being folded together along fold lines 7. Insert 16 fits between panels 11 before the panels are brought completely together. Opening 44 in the panel 16 mates with openings 10 in the hand grip side support panels. When the reinforcement panel is in place and the handle has been folded together, adhesive flap 12 is folded through the hand grip openings and upwardly on the opposite hand grip side support panel. The adhesive on the hand grip support flap provides hand grip reinforcement and helps to hold the handle together.

While the openings in the panels 11 and 16 can be formed prior to handle assembly, preferably the openings in panels 11 and member 16 are formed by a single laser cutting operation after the handle has been assembled with the member stuck in place between panels 11. By laser cutting after assembly, a single hole is formed through the handle and the openings in the panels 11 and member 16 all are in alignment. With such a construction, the handle does not have a flap 12.

To apply the handle to the mat, release paper 43 is removed from the support flaps 19 and support flaps are pressed against sheet 1 of mat 30. The support flaps are sufficiently large and the adhesive sufficiently strong that the handle remains affixed to the mat when the mat is pulled away from the window.

One handle is shown in the drawings. Two or more handles can be employed in any particular location when a two-handled grip is desired.

Preferably, the various elements of the mat and handle are formed by die cutting, although any conventional cutting or forming method can be employed.

The mat and handle can be thin and flexible, as long as they are strong enough, in which case, the mat and handle can be rolled for storage and unrolled when being applied to the window. The mat alternatively could be somewhat more rigid, as long as the mat is flexible enough to conform with curved glass.

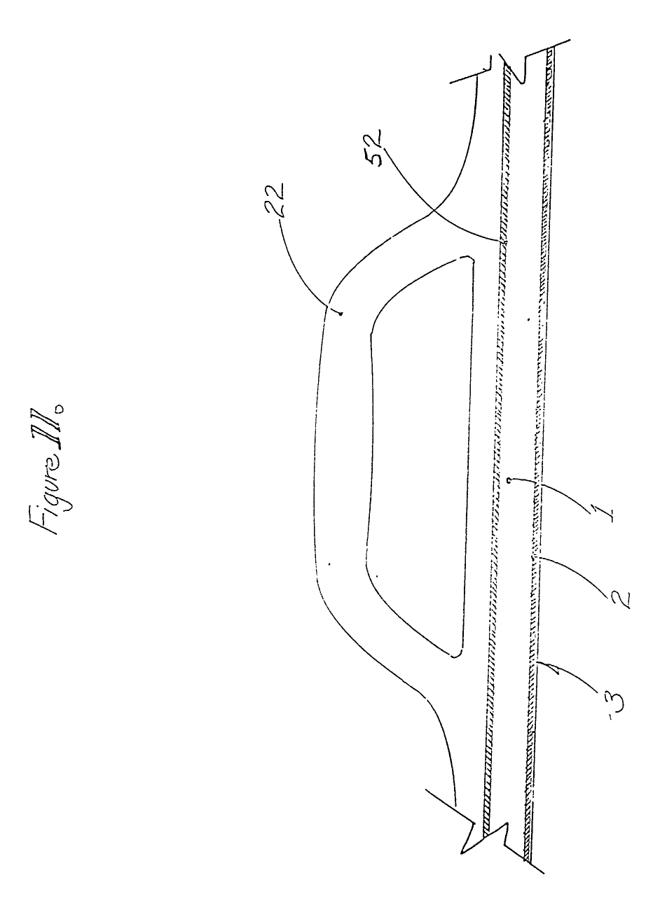

Another embodiment of the handle 22 is shown in FIG. 11. Handle 22 can be a molded handle or other integrally formed handle and can be applied to the outer surface of sheet material 1 by means of an adhesive coating 52 on the underside of the handle. Adhesive coating 52 may be protected with a release paper until the handle is to be applied to the sheet material. A double sided adhesive sheet can be used as adhesive 52.

The operation of the present invention is shown in FIGS. 1 and 2. In FIG. 1, the mat is being applied to the exterior of an unbroken window. As stated previously, the sheet does not have to be cut to conform to the size of the window but can overlap the door, so that one size can fit all windows. If desired, the sheet can be trimmed to size after it has been applied to the windows.

After the sheet has been applied to the window, the window is broken, as with a spring loaded center punch, a window breaking tool, or nail extending through hole 4. Since windows in vehicles are formed of tempered glass, the breaking of the glass causes the glass to shatter into small fragments, as shown by glass 26 in FIG. 2. The handle is then grasped by a hand 60 and pulled away from the window. In removing the broken glass, only minimal fragments of the glass 27 fall in the door or window frame, while a major portion of the glass fragments 26 are removed with the window removing device 30. This leaves an opening 28 in the door for unimpeded access to the passengers in the vehicle. Tape or scrap 50 can be applied over the edge of the window to protect against glass fragments remaining in the window frame.

It should be understood that the foregoing is merely exemplary of the present invention and that various changes in the arrangements and details of construction of the present invention may be made without departing from the spirit and scope of the present invention.

I claim:

1. A window glass remover for removing broken window glass from a frame comprising:
a mat formed of a sheet of flexible backing material shaped to substantially cover the window;
an adhesive material on one side of the backing material; and
a manually graspable handle on an opposite side of the backing mat, the materials being constructed and formed such that the adhesive material adheres to the window when applied to the side of a window, the window can thereafter be broken and the resulting glass fragments will be substantially retained on the mat by the adhesive, and the mat and fragments can be removed with the handle, thereby providing a means to break and remove a window while minimizing dispersal of broken glass fragments produced when the window is broken.

2. A window glass remover according to claim 1 wherein the mat has an opening therein for insertion of a window breaking tool, nail or other projection therethrough.

3. A window glass remover according to claim 1 wherein a bead is positioned in the hole, such that striking the bead with a hammer or the like provides a breaking force at a pressure point provided by the bead.

4. A window glass remover according to claim 3 wherein the bead is held in place by an adhesive patch that is mounted over the bead and visually marks the location of the bead.

5. A window glass remover according to claim 2 wherein the opening is visually marked to indicate the location of the opening.

6. A window glass remover according to claim 1 wherein the adhesive material comprises a double backed adhesive sheet material that adheres to the mat on one side and adheres to the window on an opposite side.

7. A window glass remover according to claim 6 wherein the adhesive material includes an aggressive adhesive on an exterior side that contacts a window, the exterior side being covered by removable release paper.

8. A window glass remover according to claim 6 wherein a bead is positioned between the mat and the adhesive material and the position of the bead is visually marked on the mat.

9. A window glass remover according to claim 8 wherein the mat is sufficiently flexible to permit the mat to be rolled up for storage prior to use.

10. A window glass remover according to claim 1 wherein the mat is formed of one or a combination of polyethylene sheeting, light vinyl sheeting, and fiberglass reinforced plastic resin sheeting.

11. A window glass remover according to claim 1 wherein the mat is formed of a tough sheeting material comprising a plastic resin.

12. A window glass remover according to claim 1 wherein the handle comprises a pressure sensitive adhesive on an exterior side that is attached to the mat.

13. A window glass remover according to claim 12 wherein the pressure sensitive adhesive comprises double sided adhesive sheeting material having an interior side that attaches to the handle and an exterior side that attaches to the mat.

14. A window glass remover according to claim 12 wherein the handle is formed of a flexible material such that the handle folds flat against the mat and can be rolled up along with the mat for storage.

15. A window glass remover according to claim 12 wherein the handle is formed from an elongated panel of sheet material, the panel having outer support flaps at opposite ends and a hand grip portion therebetween, the hand grip portion comprising a center portion of the strip that includes two sides that are folded together, the sides having mating hand grip openings therein, the pressure sensitive adhesive being on at least exterior portions of the support flaps.

16. A window glass remover according to claim 15 wherein the adhesive covers an entire side of the panel, the adhesive causing the sides of the hand grip portion to adhere together.

17. A window glass remover according to claim 16 wherein the handle further includes a reinforcement panel positioned between the sides of the hand grip portion, the reinforcement panel having a hand grip opening therethrough that is aligned with the hand grip openings in the sides of the hand grip portion, the adhesive on the sides of the hand grip portion adhering to the reinforcement panel.

18. A window glass remover according to claim 1 and further comprising a strip of mat without a handle that is wide enough to place over the periphery of a window frame to protect the user from broken glass retained at the edges of the window frame.

19. A window frame protector for protecting a person from glass fragments retained in the frame of a broken window comprising a strip of a tough, flexible plastic resin sheeting having a pressure sensitive adhesive on one side thereof and having release paper on an exposed exterior side of the adhesive, the strip being wide enough to cover an edge of a frame of an automotive window.
